(19) United States
(12) Patent Application Publication
(10) Pub. No.: US 2009/0003390 A1
(43) Pub. Date: Jan. 1, 2009

(54) Optimal Colors for a Laser Pico-Beamer

(75) Inventor: Willem Hoving, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/158,417

(22) PCT Filed: Dec. 18, 2006
(86) PCT No.: PCT/IB2006/054932

§ 371 Date: Jun. 20, 2008

Related U.S. Application Data
(60) Provisional application No. 60/752,081, filed on Dec. 20, 2005.

(51) Int. Cl. H01S 3/30

(52) U.S. Cl. 372/4

(57) ABSTRACT

A laser beam projector employs a light engine including a semiconductor laser platform (20) emitting a plurality of infrared laser beams and a frequency converter (30) emitting a plurality of primary color laser beams as a frequency conversion of the plurality of infrared laser beams, wherein each primary color laser beam has a primary color wavelength corresponding to a high sensitivity of a human eye. The laser beam projector further employs a laser beam mixer (40) emitting a projection laser beam as a mixture of the plurality of primary color laser beams.

The present invention generally relates to portable miniature laser-projectors (i.e., picobeamers) designed to be in compliance with radiation safety legislation and regulations, and long battery life time. The present invention specifically relates to a technology platform utilizing frequency conversion of electrically-pumped Vertical Cavity Surface Emitting Lasers (“VCSELs”) designed to combine a long battery-lifetime with well-chosen wavelengths of primary colors of the portable miniature laser-projector.

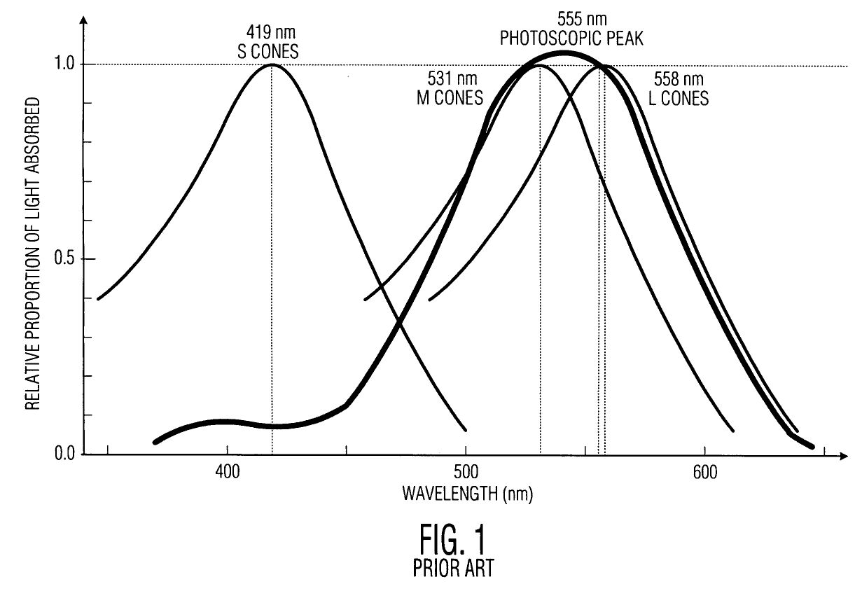

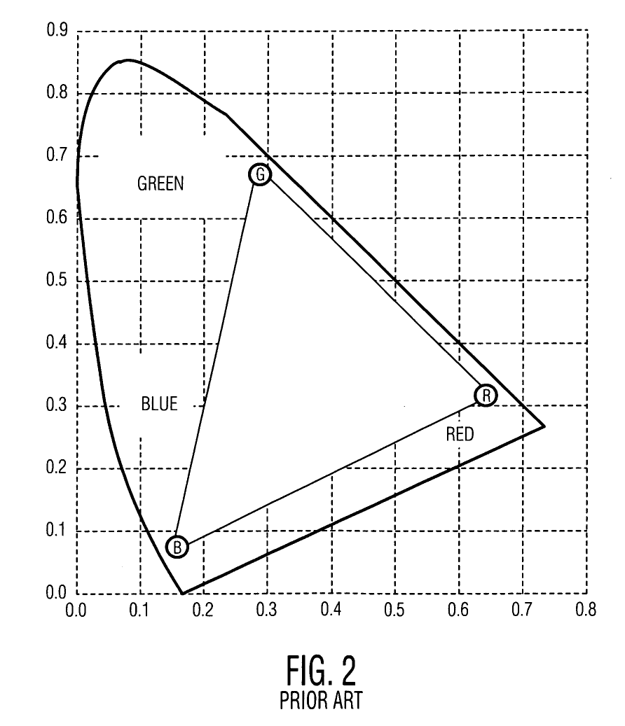

A miniature portable laser projector uses a set of three (3) primary colors including red, green and blue. These primary colors need to cover a large color gamut in view of simultaneously generating sufficient color sensation in the human eye for a bright image. For this reason, the color wavelengths of the primary colors should correspond to a high sensitivity of the human eye as shown in FIG. 1. Additionally, a large area of the color space has to be covered, such as, for example, shown in FIG. 2.

The problem of existing miniature lasers is that the currently available laser wavelengths do not match well to the eye-sensitivity maxima due to limitations in laser technology, which requires excessive optical power (eye safety threat) and excessive battery consumption (short battery life time and/or non-acceptance in specific new applications such as in cell phones). Currently, compact lasers in the form of semiconductor type lasers, lasers for optical storage and high-power lasers do not have the appropriate color wavelengths for the intended laser picobeamer applications.

Existing red laser diodes have a reasonable efficiency at infra-red wavelengths and become very inefficient below wavelengths of 635 nm. Blue laser diodes have acceptable efficiencies in the near UV regime and become in-efficient at wavelengths above 445 nm. There is no reliable semiconductor laser technology for the green color in the intermediate region from about 500 nm to 600 nm.

The present invention overcomes these drawbacks by providing a technology platform using frequency-conversion of semiconductor lasers (e.g., VCSELs) designed to obtain a power-optimized color for each primary color of the portable miniature laser-projector.

In a first form of the present invention, a light engine comprises a semiconductor laser and a frequency converter. In operation, the semiconductor laser emits an infrared laser beam, and the frequency converter emits a primary color laser beam as a frequency conversion of the infrared laser beam, wherein the primary color laser beam has a primary color wavelength corresponding to a high sensitivity of a human eye.

In a second form of the present invention, a laser beam projector comprises a light engine including a semiconductor laser platform with a frequency converter and a light beam mixer. In operation, the semiconductor laser platform emits a plurality of infrared laser beams. The frequency converter emits a plurality of primary color laser beams as a frequency conversion of the plurality of infrared laser beams, wherein each primary color laser beam has a primary color wavelength corresponding to a high sensitivity of a human eye. The laser beam mixer emits a projection laser beam as a mixture of the plurality of primary color laser beams.

The foregoing forms and other forms of the present invention as well as various features and advantages of the present invention will become further apparent from the following detailed description of various embodiments of the present invention read in conjunction with the accompanying drawings. The detailed description and drawings are merely illustrative of the present invention rather than limiting, the scope of the present invention being defined by the appended claims and equivalents thereof.

FIG. 1 illustrates a high sensitivity of a human eye for primary colors of red, green and blue as known in the art;

FIG. 2 illustrates an exemplary CIE chromaticity diagram including measurement data of the occurrence of real world colors as known in the art, also as an indication a color triangle encompassed by a laser beam projector in accordance with the present invention is shown;

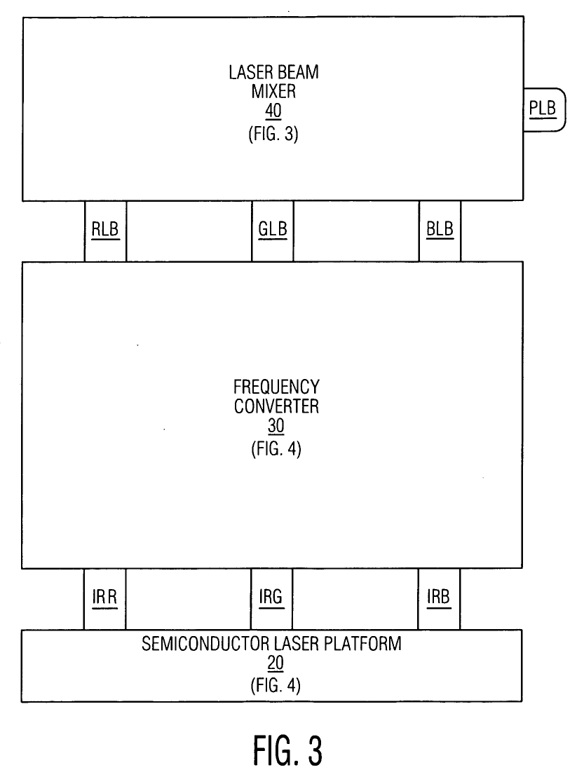

FIG. 3 illustrates a block diagram of one embodiment of a laser beam projector in accordance with the present invention; and

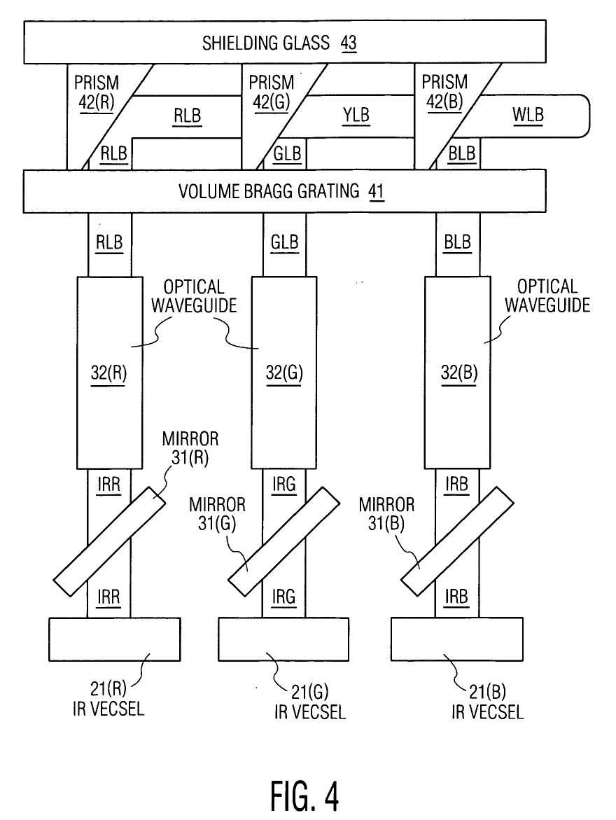

FIG. 4 illustrates a more detailed block diagram of exemplary embodiment of the laser projector illustrated in FIG. 3 in accordance with the present invention.

A laser beam projector of the present invention as shown in FIG. 3 employs a light engine including a semiconductor laser platform 20, a frequency converter 30 and a laser beam mixer 40. In operation, semiconductor laser platform 20 includes a semiconductor laser (not shown) emitting an infrared laser beam IRR whereby frequency converter 30 emits a red laser beam RLB as a frequency conversion of infrared laser beam IRR with red laser beam RLB having a red color wavelength corresponding to a high sensitivity of a human eye (e.g., approximately 630 nanometers). In one embodiment, the semiconductor laser emits infrared laser beam IRR at half the frequency of red laser beam RLB whereby frequency converter 30 doubles the frequency of infrared laser beam IRR to thereby emit red laser beam RLB as having a red color wavelength corresponding to a high sensitivity of a human eye.

Semiconductor laser platform 20 further includes another semiconductor laser (not shown) emitting an infrared laser beam IRG whereby frequency converter 30 emits a green laser beam GLB as a frequency conversion of infrared laser beam IRG with green laser beam GLB having a green color wavelength corresponding to a high sensitivity of a human eye (e.g., approximately 540 nanometers). In one embodiment, the semiconductor laser emits infrared laser beam IRG at half the frequency of green laser beam GLB whereby frequency converter 30 doubles the frequency of infrared laser beam IRG to thereby emit green laser beam GLB as having a green color wavelength corresponding to a high sensitivity of a human eye.

Semiconductor laser platform 20 further includes another semiconductor laser (not shown) emitting an infrared laser beam IRB whereby frequency converter 30 emits a blue laser beam BLB as a frequency conversion of infrared laser beam IRB with blue laser beam BLB having a blue color wavelength corresponding to a high sensitivity of a human eye (e.g., approximately 450 nanometers). In one embodiment, the semiconductor laser emits infrared laser beam IRB at half the frequency of blue laser beam BLB whereby frequency converter 30 doubles the frequency of infrared laser beam IRB to thereby emit blue laser beam BLB as having a blue color wavelength corresponding to a high sensitivity of a human eye.

Laser beam mixer 30 emits a projection laser beam PLB (e.g., a white laser beam) as a mixture of red laser beam RLB, green laser beam GLB and blue laser beam BLM.

FIG. 4 illustrates one embodiment of semiconductor laser platform 20 (FIG. 3) including three (3) infrared VCSELs 21, one embodiment of frequency converter 30 (FIG. 3) including three (3) mirrors 31 and three (3) optical waveguides 32 (e.g., periodically poled lithium niobate frequency-doubling crystals), and one embodiment of laser beam mixer 40 including a mirror 41 (e.g., a volume bragg grating), three (3) prisms 42 and a shielding glass 43.

In operation, infrared VCSEL 21 (R) emits infrared laser beam IRR for which a frequency-doubled wavelength has a red color wavelength corresponding to a high sensitivity of a human eye (e.g., approximately 630 nanometers). To this end, infrared laser beam IRR is optionally polarized by a mirror 31(R) and then frequency-doubled by optical waveguide 32(R) to thereby generate red laser beam RLB having a red color wavelength corresponding to a high sensitivity of a human eye.

Infrared VCSEL 21(G) emits infrared laser beam IRG for which a frequency-doubled wavelength has a green color wavelength corresponding to a high sensitivity of a human eye (e.g., approximately 540 nanometers). To this end, infrared laser beam IRG is optionally polarized by a mirror 31(G) and then frequency-doubled by optical waveguide 32(G) to thereby generate green laser beam GLB having a green color wavelength corresponding to a high sensitivity of a human eye.

Infrared VCSEL 21(B) emits infrared laser beam IRB for which a frequency-doubled wavelength has a blue color wavelength corresponding to a high sensitivity of a human eye (e.g., approximately 450 nanometers). To this end, infrared laser beam IRB is optionally polarized by a mirror 31(B) and then frequency-doubled by optical waveguide 32(B) to thereby generate blue laser beam BLB having a blue color wavelength corresponding to a high sensitivity of a human eye.

A prism 42(R) bends the red laser beam RLB in a direction of prism 42(G), which receives the red laser beam RLB and bends the green laser beam GLB to yield a yellow laser beam YLB in a direction of prism 42(B). The yellow laser beam YLB is received by prism 32(B), which bends the blue laser beam BLB to yield a projection beam in the form of a white laser beam WLB.

In one embodiment, the laser beam projector as shown in FIG. 4 can be packaged in accordance with current packaging technology and assembly, such as, for example, a System-in-Package technology as known in the art.

The following TABLE 1 lists exemplary results of a calculation of required laser powers for 100 lumen of balanced white light (D65) for several blue wavelengths and for a wall-plug efficiency (WPE) of 10% per color, which is representative for the current state of art conventional laser technologies:

TABLE 1

| Blue | | | | | | System |
|---|---|---|---|---|---|---|
| Wave- | | | | | | Efficiency |
| length | | BLUE | GREEN | RED | SUM | [lm/Wₑₗ] |
| 407 nm | P[mW] | 1002.5 | 121.8 | 124.5 | 1248.8 | |
| | Intensity | 3.8 | 73.6 | 22.5 | 100 | |
| | [lm] | | | | | |
| Electrical Power [W] | | 6.7 | 1.22 | 1.25 | 9.15 | 10.9 |
| | | | | | | lm/Watt |
| 435 nm | P[mW] | 94.2 | 123.2 | 129.6 | 347.0 | |
| | Intensity | 2.1 | 74.4 | 23.5 | 100 | |
| | [lm] | | | | | |
| Electrical Power [W] | | 0.9 | 1.2 | 1.3 | 3.4 | 28.8 |
| | | | | | | lm/Watt |
| 440 nm | P[mW] | 87.7 | 122.5 | 130.7 | 340.9 | |
| | Intensity | 2.3 | 74.1 | 23.7 | 100 | |
| | [lm] | | | | | |
| Electrical Power [W] | | 0.88 | 1.23 | 1.31 | 3.41 | 29.3 |
| | | | | | | lm/Watt |
| 460 nm | P[mW] | 92.6 | 117.3 | 139.8 | 349.8 | |
| | Intensity | 3.8 | 70.9 | 25.3 | 100 | |
| | [lm] | | | | | |
| Electrical Power [W] | | 0.9 | 1.2 | 1.4 | 3.5 | 28.6 |
| | | | | | | lm/Watt |
| 473 nm | P[mW] | 136.9 | 104.7 | 151.7 | 393.3 | |
| | Intensity | 9.3 | 63.3 | 27.5 | 100 | |
| | [lm] | | | | | |

| | | | | | |
|---|---|---|---|---|---|
| Electrical Power [W] | 1.4 | 1.1 | 1.5 | 3.9 | 25.4 |
| | | | | | lm/Watt |

From TABLE 1, a theoretical system efficiency of about 29 lumens per electrical Watt can be achieved (neglecting optical losses).

The following TABLE 2 lists exemplary results of a calculation of required VCSEL laser powers for 100 lumen of balanced white light (D65) for several blue wavelengths and for a wall-plug efficiency of 30%:

TABLE 2

| Blue | | | | | | System |
|---|---|---|---|---|---|---|
| Wave- | | | | | | Efficiency |
| length | | BLUE | GREEN | RED | SUM | [lm/Wₑₗ] |
| 407 nm | P[mW] | 1002.5 | 121.8 | 124.5 | 1248.8 | |
| | Intensity | 3.9 | 73.6 | 22.5 | 100 | |
| | [lm] | | | | | |
| Electrical Power [W] | | 5.0 | 0.4 | 0.5 | 5.8 | 17.1 |
| | | | | | | lm/Watt |
| 435 nm | P[mW] | 94.2 | 123.2 | 129.6 | 347.0 | |
| | Intensity | 2.1 | 74.4 | 23.5 | 100 | |
| | [lm] | | | | | |
| Electrical Power [W] | | 0.5 | 0.4 | 0.4 | 1.3 | 76.1 |
| | | | | | | lm/Watt |
| 440 nm | P[mW] | 87.7 | 122.5 | 130.7 | 341.0 | |
| | Intensity | 2.3 | 74.1 | 23.7 | 100 | |
| | [lm] | | | | | |
| Electrical Power [W] | | 0.3 | 0.4 | 0.4 | 1.1 | 88.0 |
| | | | | | | lm/Watt |
| 460 nm | P[mW] | 92.8 | 117.3 | 139.8 | 349.8 | |
| | Intensity | 3.8 | 70.9 | 25.3 | 100 | |
| | [lm] | | | | | |
| Electrical Power [W] | | 0.3 | 0.4 | 0.5 | 1.1 | 85.8 |
| | | | | | | lm/Watt |
| 473 nm | P[mW] | 136.9 | 104.7 | 151.7 | 393.3 | |
| | Intensity | 9.3 | 63.3 | 27.5 | 100 | |
| | [lm] | | | | | |

| | | | | | |
|---|---|---|---|---|---|
| Electrical Power [W] | 0.5 | 0.3 | 0.5 | 1.3 | 76.3 |
| | | | | | lm/Watt |

From TABLE 2, a theoretical system efficiency of about 88 lumens per electrical Watt can be achieved (neglecting optical losses). This implies in reality a total electrical power (e.g., battery) of typically 450 mWatt will be required for 40 lumen white output.

For the anticipated WPE of 30% per color, the frequency-doubled VCSEL technology of the present invention achieves almost 88 lumens per Watt, which is an interesting number for a battery-operated device. If the optical system efficiency is 80% (which is a pessimistic estimate for a mini-beamer using a MEMS scanner), then the optical output power for 80 lumens on the screen amounts to roughly 340 mW, which is much lower than for existing laser technology not using these “optimal colors”. Power consumption from the batteries is typically 1.1 Watts, and the power dissipation is so low that active cooling of the lasers will not be needed.

Referring to FIGS. 3 and 4, those having ordinary skill in the art will appreciate numerous advantages of the present invention including, but not limited to, providing a solution to an incompatibility of the primary colors that can be generated with other micro-laser technology involving an eye sensitivity and color space to make an optimum light engine from a point of view of power consumption and light safety. In particular, the present invention uses one single laser technology platform of VCSEL lasers to obtain “optimal colors” for each of the primary colors of the picobeamer, which are about 450 mn for Blue, 540 nm for Green and 630 nm for Red, respectively, corresponding to a good match with the color triangle, a high color sensitivity of the human eyes and minimum optical radiation doses. The color space that can be generated with these primary colors corresponds to most colors in nature, and is more than sufficient for the foreseen portable applications of the picobeamer, so there will be a good color reproduction with minimal radiation load.

In addition, the wall-plug efficiencies of the proposed color-converted VCSEL-based platform are foreseen to reach 20-30% for each color in foreseeable future, which is much better than those of conventional lasers (edge-emitting laser diodes or any other compact micro-laser technology, such as diode-pumped solid-state lasers) which are in the 5-15% WPE range depending of the color. This means that the power consumption for the VCSEL based RGB light source is a factor of 2 or 3 lower than using conventional laser sources, so that the battery lifetime is correspondingly longer. This will enable battery-operated picobeamers as a new consumer product.

While the embodiments of the present invention disclosed herein are presently considered to be preferred, various changes and modifications can be made without departing from the spirit and scope of the present invention. The scope of the present invention is indicated in the appended claims, and all changes that come within the meaning and range of equivalents are intended to be embraced therein.

The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A light engine for a laser beam projector, the light engine comprising:
a semiconductor laser (20) operable to emit an infrared laser beam; and
a frequency converter (30) operable to be in optical communication with the semiconductor laser (20) to emit a primary color laser beam as a frequency conversion of the infrared laser beam, wherein the primary color laser beam has a primary color wavelength corresponding to a high sensitivity of a human eye.

2. The light engine of claim 1, wherein the primary color laser beam is a red laser beam having a red color wavelength corresponding to the high sensitivity of the human eye.

3. The light engine of claim 2, wherein the red color wavelength approximates 630 nanometers.

4. The light engine of claim 1, wherein the primary color laser beam is a green laser beam having a green color wavelength corresponding to the high sensitivity of the human eye.

5. The light engine of claim 4, wherein the green color wavelength approximates 540 nanometers.

6. The light engine of claim 1, wherein the primary color laser beam is a blue laser beam having a blue color wavelength corresponding to the high sensitivity of the human eye.

7. The light engine of claim 6, wherein the blue color wavelength approximates 450 nanometers.

8. The light engine of claim 1, wherein the semiconductor laser (20) is a vertical cavity surface emitting laser (21) operable to emit the infrared laser beam.

9. The light engine of claim 1, wherein the frequency converter (21) includes an optical waveguide (32) operable to be in optical communication with the semiconductor laser (20) to double a frequency of the infrared laser beam.

10. The light engine of claim 1,
wherein the semiconductor laser (20) is a vertical cavity surface emitting laser (21) operable to emit the infrared laser beam; and
wherein the frequency converter (21) includes an optical waveguide (32) operable to be in optical communication with the vertical cavity surface emitting laser (21) to double a frequency of the infrared laser beam.

11. A laser beam projector, comprising:
a light engine including:
a semiconductor laser platform (20) operable to emit a plurality of infrared laser beams; and
a frequency converter (30) operable to be in optical communication with the semiconductor laser platform (20) to emit a plurality of primary color laser beams as a frequency conversion of the plurality of infrared laser beams, wherein each primary color laser beam has a primary color wavelength corresponding to a high sensitivity of a human eye; and
a laser beam mixer (40) operable to be in optical communication with the frequency converter (30) to emit a projection laser beam as a mixture of the plurality of primary color laser beams.

12. The laser beam projector of claim 11, wherein at least one of the primary color laser beams is a red laser beam having a red color wavelength corresponding to the high sensitivity of the human eye.

13. The laser beam projector of claim 12, wherein the red color wavelength approximates 630 nanometers.

14. The laser beam projector of claim 11, wherein at least one of the primary color laser beams is a green laser beam having a green color wavelength corresponding to the high sensitivity of the human eye.

15. The laser beam projector of claim 14, wherein the green color wavelength approximates 540 nanometers.

16. The laser beam projector of claim 11, wherein at least one of the primary color laser beams is a blue laser beam having a blue color wavelength corresponding to the high sensitivity of the human eye.

17. The laser beam projector of claim 16, wherein the blue color wavelength approximates 450 nanometers.

18. The laser beam projector of claim 11, wherein the semiconductor laser platform (20) includes a vertical cavity surface emitting laser (21) operable to emit a first infrared laser beam.

19. The laser beam projector of claim 11, wherein the frequency converter (21) includes an optical waveguide (32) operable to be in optical communication with the semiconductor laser platform (20) to double a frequency of a first infrared laser beam.

20. The laser beam projector of claim 11,
wherein the semiconductor laser platform (20) includes a vertical cavity surface emitting laser (21) operable to emit a first infrared laser beam; and
wherein the frequency converter (21) includes an optical waveguide (32) operable to be in optical communication with the vertical cavity surface emitting laser (21) to double a frequency of the first infrared laser beam.

21. The laser beam projector of claim 11, wherein the primary color laser beam mixer (40) includes a plurality of prisms (42) optically aligned to mix the primary color laser beams.
